(19) United States
(12) Patent Application Publication
(10) Pub. No.: US 2019/0005653 A1
(43) Pub. Date: Jan. 3, 2019

(54) METHOD AND APPARATUS FOR EXTRACTING FOREGROUND

(71) Applicant: SAMSUNG SDS CO., LTD., Seoul (KR)

(72) Inventors: Jung Ah CHOI, Seoul (KR); Jin Ho CHOO, Seoul (KR); Jong Hang KIM, Seoul (KR); Jeong Seon YI, Seoul (KR); Ji Hoon KIM, Seoul (KR)

(73) Assignee: SAMSUNG SDS CO., LTD., Seoul (KR)

(21) Appl. No.: 16/025,466

(22) Filed: Jul. 2, 2018

(30) Foreign Application Priority Data
Jul. 3, 2017 (KR) 10-2017-0084002

(51) Int. Cl. G06T 7/194; G06T 7/11; H04N 19/137; H04N 19/625; H04N 19/176; G06K 9/46

(52) U.S. Cl. CPC G06T 7/194; G06T 7/11; G06K 9/4638; H04N 19/625; H04N 19/176; H04N 19/137

(57) ABSTRACT

A method includes acquiring, by a device, encoded image data corresponding to an original image. The method includes decoding, by the device, the encoded image data. The method included acquiring, by the device, a foreground extraction target frame and an encoding parameter associated with an encoding process of the original image based on decoding the encoded image data. The method includes extracting, by the device, a first candidate foreground associated with the foreground extraction target frame based on the encoding parameter. The method includes extracting, by the device, a second candidate foreground associated with the foreground extraction target frame based on a preset image processing algorithm. The method includes determining, by the device, a final foreground associated with the foreground extraction target frame based on the first candidate foreground and the second candidate foreground.

This application claims priority from Korean Patent Application No. 10-2017-0084002 filed on Jul. 3, 2017 in the Korean Intellectual Property Office, the disclosure of which is incorporated herein by reference in its entirety.

### BACKGROUND

### 1. Field of the Invention

The present invention relates to a method and apparatus for extracting a foreground. More specifically, the present invention relates to a method and apparatus for extracting a foreground in which a foreground is extracted by dividing an image into a foreground region and a background region.

### 2. Description of the Related Art

Recently, as the installation of closed circuit television (CCTV) has spread, interests in intelligent image analysis technology have increased for efficient monitoring. The intelligent image analysis technology is a technology of detecting predefined events through image analysis and automatically transmitting alarms. Examples of events detected in the intelligent image analysis include intrusion detection and object counting.

The intelligent image analysis is performed, for example, through foreground extraction, object detection, object tracking, and event detection. At this time, foreground objects extracted by dividing an image into a background and a foreground in the foreground extracting process continue to be used as basic data for objection detection and tracking. Therefore, the foreground extracting process is a basic and important process in the intelligent image analysis.

FIG. 1 shows a process in which the above-described foreground extraction is actually performed. Referring to FIG. 1, since the image data received from an image capturing device such as CCTV is encoded image data, a decoding process is first performed on the encoded image data. Next, a foreground region is extracted from the decoded image data. At this time, since the extracted foreground region includes various noises due to illumination variation, noise on a sensor, and the like, image post-processing for removing noises is essentially performed.

In order to extract a foreground from an image as described above, various foreground extracting algorithms have been proposed so far. However, most of the proposed algorithms have problems such as low accuracy, sensitivity to noise, and high computational complexity. Specifically, since frame difference-based algorithms are very poor in foreground extraction accuracy and GMM (Gaussian mixture model)-based algorithms are sensitive to noise to require a large amount of computation in the image post-processing, there is a problem that it takes a considerable time to extract the foreground. Therefore, it is difficult to apply the proposed algorithms to the intelligent image analysis requiring accurate foreground extraction in real time.

Accordingly there is required a method capable of rapidly extracting a foreground through an operation of resistance to noise and low complexity.

### SUMMARY

An aspect of the present invention is to provide a method and apparatus for extracting a foreground, which has resistance to noise and can guarantee a certain level of accuracy and reliability over foreground extraction results.

Another aspect of the present invention is to provide a method and apparatus for extracting a foreground, which can rapidly separate a foreground and a background by reducing the complexity of operations used for foreground extraction.

In accordance with an aspect of the disclosure, there is provided a method, comprising: acquiring, by a device, encoded image data corresponding to an original image; decoding, by the device, the encoded image data; acquiring, by the device, a foreground extraction target frame and an encoding parameter associated with an encoding process of the original image based on decoding the encoded image data; extracting, by the device, a first candidate foreground associated with the foreground extraction target frame based on the encoding parameter; extracting, by the device, a second candidate foreground associated with the foreground extraction target frame based on a preset image processing algorithm; and determining, by the device, a final foreground associated with the foreground extraction target frame based on the first candidate foreground and the second candidate foreground.

In accordance with another aspect of the disclosure, there is provided a method, comprising: acquiring, by a device, encoded image data associated with an original image that was encoded based on an encoding process; decoding, by the device, the encoded image data and acquiring a foreground extraction target frame and an encoding parameter associated with the encoding process based on decoding the encoded image data, wherein the encoding parameter includes a motion vector; and extracting, by the device, a foreground associated with the foreground extraction target frame using a cascade classifier based on the motion vector.

In accordance with another aspect of the disclosure, there is provided an apparatus, comprising: a memory configured to store instructions; and at least one processor configured to execute the instructions to: acquire encoded image data generated through an encoding process performed on an original image; perform a decoding process on the encoded image data and acquire a foreground extraction target frame and an encoding parameter associated with the encoding process based on the decoding process; extract a first candidate foreground associated with the foreground extraction target frame using the encoding parameter; extract a second candidate foreground associated with the foreground extraction target frame using a preset image processing algorithm; and determine a final foreground associated with the foreground extraction target frame based on the first candidate foreground and the second candidate foreground.

However, aspects of the present invention are not restricted to the one set forth herein. The above and other aspects of the present invention will become more apparent to one of ordinary skill in the art to which the present invention pertains by referencing the detailed description of the present invention given below.

### BRIEF DESCRIPTION OF THE DRAWINGS

The above and other aspects and features of the present invention will become more apparent by describing in detail exemplary embodiments thereof with reference to the attached drawings, in which:

FIG. 1 is a schematic block diagram illustrating a conventional foreground extracting process;

FIG. 2 is a block diagram of an intelligent image analysis system according to an embodiment of the present invention;

FIG. 3 is a block diagram for explaining input/output data of a foreground extracting apparatus according to an embodiment of the present invention;

FIGS. 4A to 4C are block diagrams illustrating a foreground extracting apparatus according to another embodiment of the present invention;

FIG. 5 is a hardware block diagram of a foreground extracting apparatus according to still another embodiment of the present invention;

FIG. 6 is a flowchart of a foreground extracting method according to still another embodiment of the present invention;

FIGS. 7 to 8B are diagrams for explaining the first candidate foreground extracting step (S300) based on the encoding parameters shown in FIG. 6;

FIGS. 9A and 9B are diagrams for explaining a method of matching foreground classification units of a candidate foreground which can be referred to in some embodiments of the present invention;

FIG. 10 is a diagram for explaining the final foreground determining step (S500) based on the MRF model shown in FIG. 6; and

FIGS. 11A to 16 are diagrams for explaining comparative experimental results of a conventional foreground extracting method and a foreground extracting method according to some embodiments of the present invention.

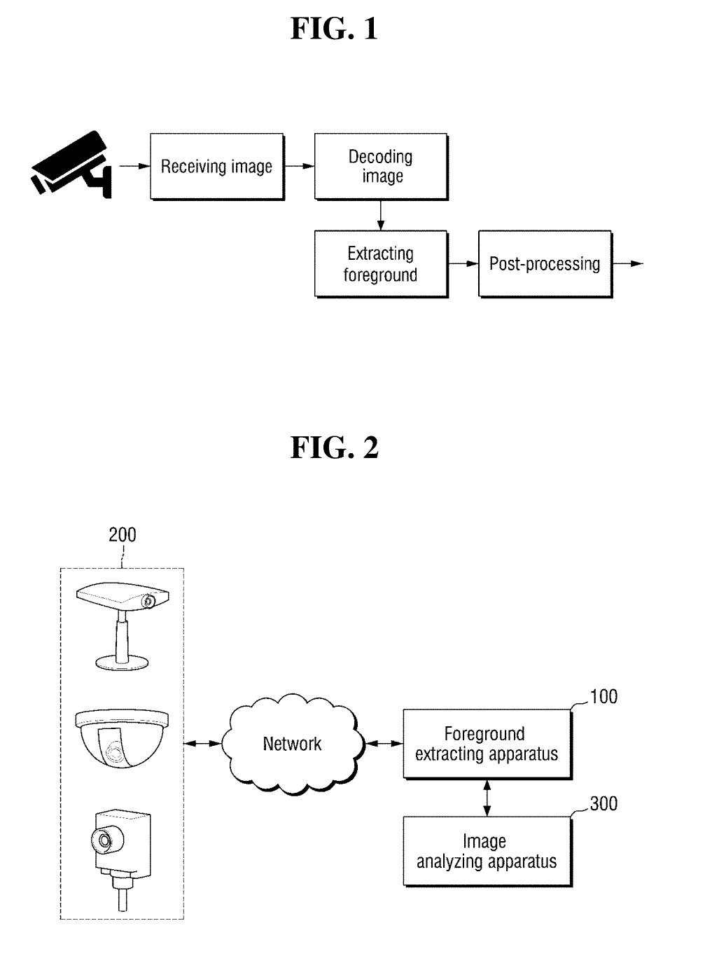

### DETAILED DESCRIPTION OF THE EMBODIMENTS

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the the present invention to those skilled in the art, and the present invention will only be defined by the appended claims. In the drawings, the size and relative sizes of layers and regions may be exaggerated for clarity. Like reference numerals refer to like elements throughout the specification. The terminology used herein is for the purpose of describing particular embodiments only and is not intended to be limiting of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the specification and will not be interpreted in an idealized or overly formal sense unless expressly so defined herein.

It will be further understood that the terms “comprises” and/or “comprising,” or “includes” and/or “including” when used in this specification, specify the presence of stated features, regions, integers, steps, operations, instructions, elements, components, and/or groups, but do not preclude the presence or addition of one or more other features, regions, integers, steps, operations, instructions, elements, components, and/or groups thereof.

Hereinafter, embodiments of the present invention will be described with reference to the attached drawings.

FIG. 2 is a block diagram of an intelligent image analysis system according to an embodiment of the present invention.

Referring to FIG. 2, an intelligent image analysis system according to an embodiment of the present invention is a system for performing intelligent image analysis from collected images using various image processing techniques. For example, the intelligent image analysis system may be a people counting system that provides business intelligence information such as the number of visitors by time or place, the residence time of visitors, or the travel route of visitors, or may be an intelligent monitoring system that performs intrusion detection, object recognition, or objet tracking. However, the present invention is not limited thereto.

In this embodiment, the intelligent image analysis system may include an image capturing apparatus 200, a foreground extracting apparatus 100, and an image analyzing apparatus 300. However, this configuration is only a preferred embodiment for achieving an object of the present invention, and, if necessary, some components may be added or omitted. Further, the respective components of the intelligent image analysis system shown in FIG. 2 represents functionally distinct functional elements, and it should be noted that one or more components may be implemented in such a manner that they are integrated with each other in an actual physical environment.

In the intelligent image analysis system, the image capturing apparatus 200 is an apparatus for providing image data generated through image capturing. The image capturing apparatus 200 may be implemented as, for example, a CCTV camera, but the present invention is not limited thereto.

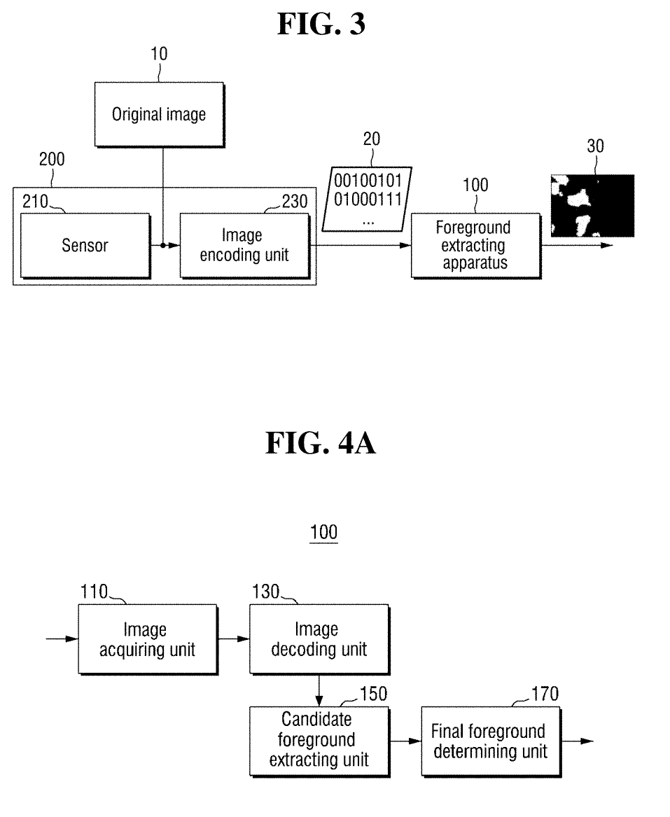

As shown in FIG. 3, the image capturing apparatus 200 may include a sensor 210 and an image encoding unit 230. The sensor 210 may generate an original image 10, which is raw data, through image capturing, and the image encoding unit 230 may generate image data 20 encoded in the form of a bitstream through an encoding process for the original image 10.

Here, the encoding process may be a process of converting an original image into a designated image format. Examples of the image format may include, but are not limited to, standard image formats such as MPEG-1, MPEG-2, MPEG-4, and H-264.

In the intelligent image analysis system, the foreground extracting apparatus 100 is a computing apparatus that extracts foreground by separating foreground and background from a given image. Here, examples of the computing apparatus may include, but are not limited to, a notebook, a desk top, and a laptop, and may include all kinds of apparatuses equipped with computing means and communication means. However, since foreground extraction must be performed faster than anything else in order to perform intelligent image analysis in real time, the foreground extracting apparatus 100 may be preferably implemented as a high-performance server computing apparatus.

Specifically, as shown in FIG. 3, the foreground extracting apparatus 100 receives image data 20 encoded in the form of a bitstream, acquires at least one foreground extraction target frame and encoding parameters through a decoding process, and performs foreground extraction from each foreground extraction target frame using the encoding parameters. The extracted foreground result 30 is referred to FIG. 3.

According to an embodiment of the present invention, the encoding parameter may include a motion vector (MV), a discrete cosine transform (DCT) coefficient, and partition information including the number and size of prediction blocks. However, the present invention is not limited thereto.

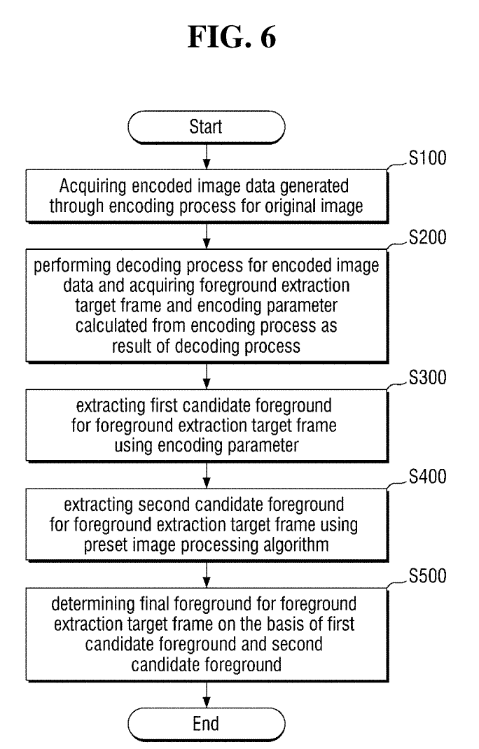

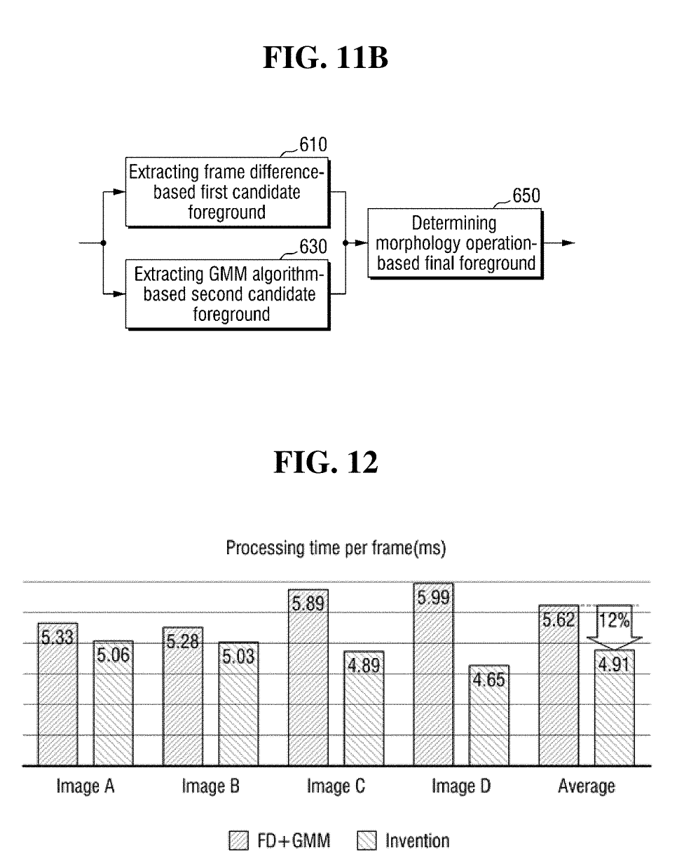

In an embodiment, the foreground extracting apparatus 100 may extract a first candidate foreground using the encoding parameters, and may extract a second candidate foreground using a preset image processing algorithm. Further, the foreground extracting apparatus 100 may determine a final foreground for a foreground extraction target frame from the first and second candidate foregrounds using a Markov Random Field (MRF) model. Here, the preset image processing algorithm may be, for example, a frame difference-based image processing algorithm or a GMM-based image processing algorithm, but is not limited thereto, and at least one image processing algorithm widely known in the art may be used without limitation. According to this embodiment, since the final foreground is determined using a plurality of candidate foregrounds, there is an advantage that the accuracy and reliability of the extracted foreground results can be improved. However, even according to this embodiment, it was found from comparative experimental results that the complexity of the entire operation is not high. The above comparative experimental results are referred to the experimental results shown in FIGS. 11 to 13. Further, details of this embodiment will be described later with reference to FIGS. 6 to 10.

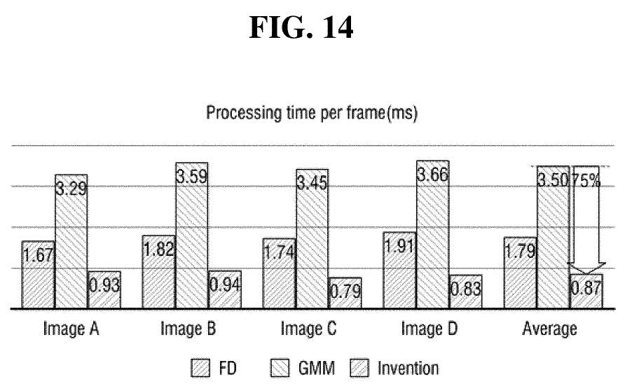

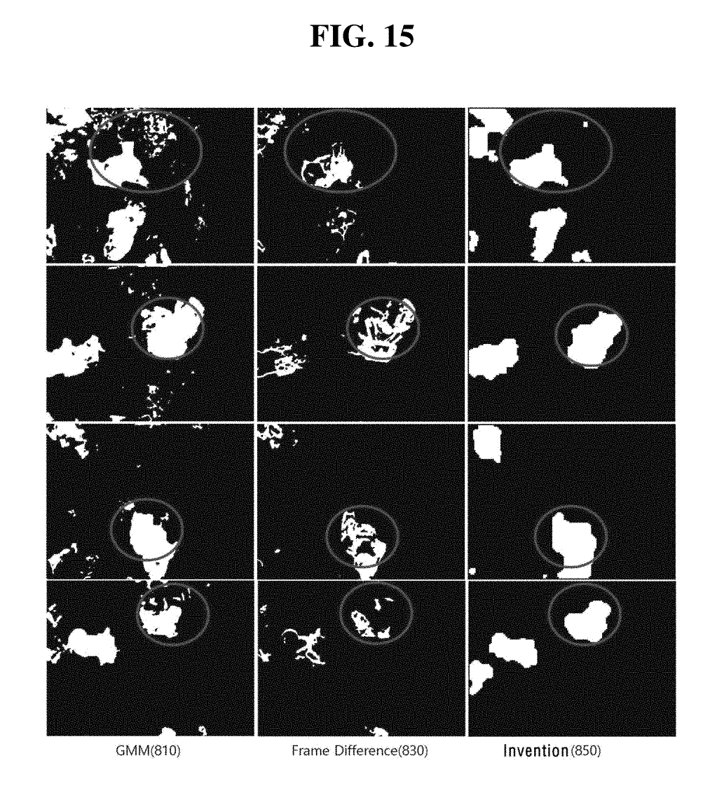

In another embodiment, the foreground extracting apparatus 100 may extract a first candidate foreground for a foreground extraction target frame using the encoding parameters, and may determine a final foreground for the foreground extraction target frame from the first candidate foreground using the MRF model. According to this embodiment, since the final foreground is determined directly from a single candidate foreground, there is an advantage that the foreground extraction results can be provided quickly. However, even according to this embodiment, it was found from comparative experimental results that a foreground having resistance to noise and high accuracy can be extracted. The above comparative experimental results are referred to the experimental results shown in FIGS. 14 and 15.

In the intelligent image analysis system, the image analyzing apparatus 300 is a computing apparatus for performing intelligent image analysis on the basis of foreground information provided by the foreground extracting apparatus 100. For example, the image analyzing apparatus 300 may recognize an object from the extracted foreground, track the recognized object, or perform image analysis for object counting.

In the intelligent image analysis system, the foreground extracting apparatus 100 and the image capturing apparatus 200 may communicate with each other through a network. Here, as the network, all kinds of wired/wireless networks such as local area network (LAN), wide area network (WAN), mobile radio communication network, and wireless broadband internet (WIBRO) may be used.

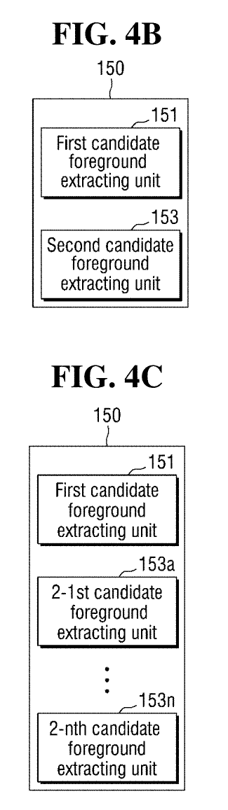

Up to now, an intelligent image analysis system according to an embodiment of the present invention has been described with reference to FIGS. 2 and 3. Hereinafter, the detailed configuration and operation of the foreground extracting apparatus 100 according to the embodiment of the present invention will be described with reference to FIGS. 4A to 4C.

Referring to FIG. 4A, the foreground extracting apparatus 100 may include an image acquiring unit 110, an image decoding unit 130, a candidate foreground extracting unit 150, and a final foreground determining unit 170. However, only the components related to the embodiment of the present invention are not shown in FIG. 4A. Accordingly, it can be understood by those skilled in the art that other general-purpose components other than the components shown in FIG. 4A may be further included. Further, the respective components of the foreground extracting apparatus shown in FIG. 4A represents functionally distinct functional elements, and it should be noted that one or more components may be implemented in such a manner that they are integrated with each other in an actual physical environment. Hereinafter, the respective components of the foreground extracting apparatus 100 will be described.

The image acquiring unit 110 acquires encoded image data. For example, the image acquiring unit 110 may receive image data encoded in the form of a bitstream in real time, but the method of acquiring the encoded image data using the image acquiring unit 110 is not limited thereto.

The image decoding unit 130 performs a decoding process of the encoded image data acquired by the image acquiring unit 110, and acquires a foreground extraction target frame and encoding parameters as a result of the decoding process. Since the decoding process is already obvious to those skilled in the art, a detailed description thereof will be omitted.

The candidate foreground extracting unit 150 extracts a candidate foreground from the foreground extraction target frame. For this purpose, as shown in FIG. 4B, the candidate foreground extracting unit 150 may be configured to include a first candidate foreground extracting unit 151 and a second candidate foreground extracting unit 153.

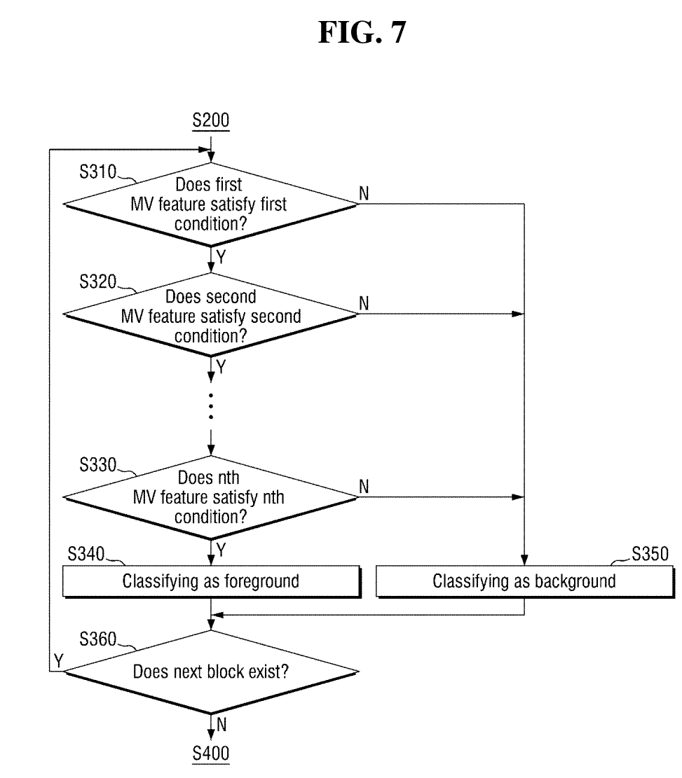

The first candidate foreground extracting unit 151 extracts a first candidate foreground for the foreground extraction target frame using the encoding parameters acquired as a result of the decoding process. Details thereof will be described later with reference to FIG. 7.

The second candidate foreground extracting unit 153 extracts a second candidate foreground for the foreground extraction target frame using a preset image processing algorithm. Here, as the preset image processing algorithm, any algorithm may be used.

According to an embodiment of the present invention, the second candidate foreground extracting unit 153 may extract a plurality of second candidate foregrounds using a plurality of image processing algorithms in order to improve the accuracy and reliability of the foreground extraction result. In this case, as shown in FIG. 4C, the second candidate foreground extracting unit 153 may be configured to include a plurality of second candidate foreground extracting units 153a to 153n.

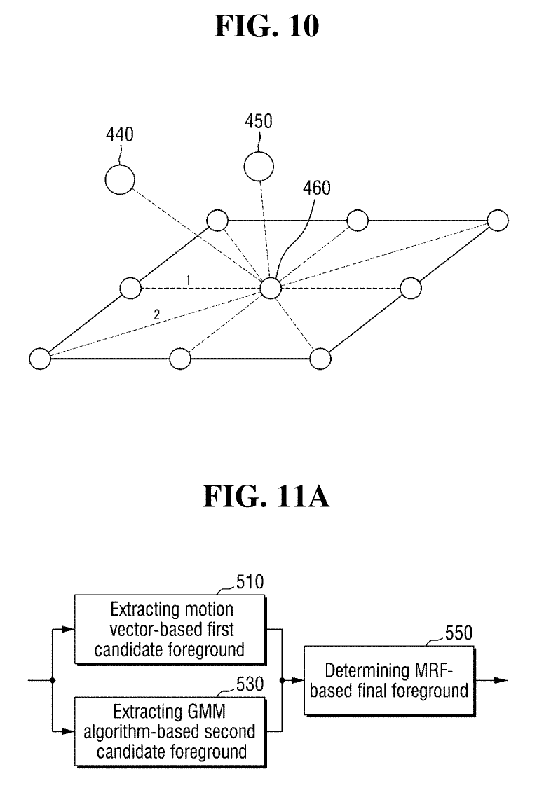

The final foreground determining unit 170 determines a final foreground from at least one candidate foreground using the MRF model. For example, the final foreground determining unit 170 may determine a final foreground by performing an operation that minimizes an MRF-based energy function. Details thereof will be described later with reference to FIG. 10.

Each of the components in FIGS. 4A to 4C may refer to software or hardware such as an FPGA (Field Programmable Gate Array) or an ASIC (Application-Specific Integrated Circuit). However, the components are not limited to software or hardware, and may be configured to be stored in an addressable storage medium, and configured to execute one or more processors. The functions provided in the components may be implemented by a more detailed component, or may be implemented by a single component that performs a specific function by combining a plurality of components.

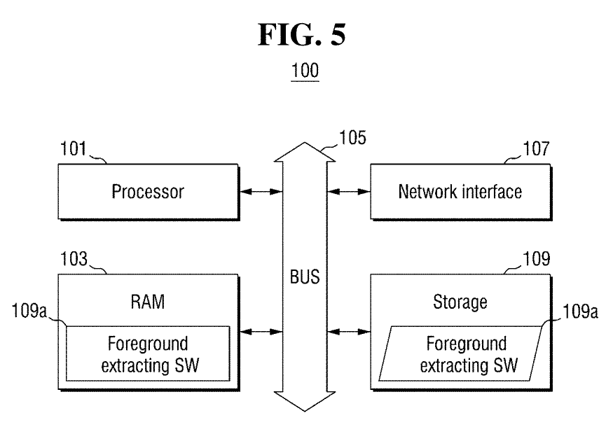

FIG. 5 is a hardware block diagram of a foreground extracting apparatus 100 according to still another embodiment of the present invention.

Referring to FIG. 5, the foreground extracting apparatus 100 may include at least one processor 101, a bus 105, a network interface 107, a memory 103 loading a computer program executed by the processor 101, and a storage 109 for storing foreground extracting software 109a. However, FIG. 5 shows only the components related to embodiments of the present invention. Accordingly, those skilled in the art will appreciate that other general-purpose components may be included in addition to the components shown in FIG. 5.

The processor 101 controls the overall operation of each component of the foreground extracting apparatus 100. The processor 101 may be configured to include a central processing unit (CPU), a micro processor unit (MPU), a microcontroller unit (MCU), a graphic processing unit (GPU), or any type of processor that is well known in the art. Further, the processor 101 may perform operations on at least one application or program for executing a method according to embodiments of the present invention. The foreground extracting apparatus 100 may include one or more processors.

The memory 103 stores various data, commands and/or information. The memory 103 may load one or more programs 109a from the storage 109 in order to execute a foreground extracting method according to embodiments of the present invention. FIG. 6 shows RAM as an example of the memory 103.

The bus 105 provides a communication function between the components of the foreground extracting apparatus 100. The bus 105 may be implemented as various types of buses such as an address bus, a data bus, and a control bus.

The network interface 107 supports wired/wireless internet communication of the foreground extracting apparatus 100. In addition, the network interface 107 may support various communication methods other than internet communication. For this purpose, the network interface 107 may be configured to include a communication module that is well known in the art.

The storage 109 may non-temporarily store the one or more programs 109a. In FIG. 5, foreground extracting software 109a is shown as an example of the one or more programs 109a.

The storage 109 may be configured to include non-volatile memory such as ROM (Read Only Memory), EPROM (Erasable Programmable ROM), EEPROM (Electrically Erasable Programmable ROM), or flash memory, hard disk, detachable disk, or any type of computer-readable recording medium well known in the art to which the present invention pertains.

The foreground extracting software 109a may perform a foreground extracting method according to an embodiment of the present invention.

Specifically, the foreground extracting software may be loaded in the memory 103, and may execute the following operations using one or more processor 101, the operations including: acquiring encoded image data generated by an encoding process for an original image; performing the encoding process for the encoded image data and acquiring a foreground extraction target frame and encoding parameters calculated from the encoding process as a result of the encoding process; extracting a first candidate foreground for the foreground extraction target frame using the encoding parameters; extracting a second candidate foreground for the foreground extraction target frame using a preset image processing algorithm; and determining a final foreground for the foreground extraction target frame on the basis of the first candidate foreground and the second candidate foreground.

Or, the foreground extracting software may execute the following operations: acquiring encoded image data generated by an encoding process for an original image; performing the encoding process for the encoded image data and acquiring a foreground extraction target frame and encoding parameters calculated from the encoding process as a result of the encoding process, the encoding parameter including motion vectors; and extracting a foreground for the foreground extraction target frame using a cascade classifier based on the motion vector.

Up to now, the foreground extracting apparatus 100 according to the embodiment of the present invention has been described with reference to FIGS. 3 to 5. Next, a foreground extracting method according to still another embodiment of the present invention will be described in detail with reference to FIGS. 6 to 10.

Each step of the foreground extracting method according to an embodiment of the present invention, which will be described later, may be performed by a computing apparatus. For example, the computing apparatus may be a foreground extracting apparatus 100. For the convenience of explanation, a description of operation subject of each step included in the foreground extracting method may be omitted. In addition, each step of the foreground extracting method may be an operation performed in the foreground extracting apparatus 100 by allowing the processor 101 to execute the foreground extracting software 109a.

FIG. 6 is a flowchart of a foreground extracting method according to an embodiment of the present invention. However, this is only a preferred embodiment for attaining an object of the present invention, and some steps may be added or deleted as needed.

Referring to FIG. 6, the foreground extracting apparatus 100 acquires encoded image data generated through an encoding process for an original image (S100). For example, the encoded image data may refer to an image bitstream encoded by a preset image format. As described above, the image format may include standard image formats such as MPEG-1, MPEG-2, MPEG-4, and H-264. The foreground extracting apparatus 100 may acquire image data in a manner that receives the encoded image data through a network in real time, but the method of acquiring the encoded image data by the foreground extracting apparatus 100 is limited thereto.

Next, the foreground extracting apparatus 100 performs the decoding process for the encoded image data, and acquires a foreground extraction target frame and encoding parameters calculated from the encoding process as a result of the decoding process (S200). As described above, the encoding parameters may include a motion vector, a DCT coefficient, and partition information including the number and size of prediction blocks.

In order to provide the convenience of understanding, briefly explaining the motion vector among the encoding parameters, as a block matching algorithm is performed in a unit of prediction block in the encoding process, a motion vector is calculated in a prediction block, and the motion vector is included in the image data encoded in the form of a difference value. Therefore, in the decoding process, a motion vector in a unit of prediction block may be acquired again using the difference value of the motion vector. Since it is obvious that those skilled in the art can understand such contents, a detailed description thereof will be omitted.

Next, the foreground extracting apparatus 100 extracts a first candidate foreground for the foreground extraction target frame using the encoding parameters (S300). Specifically, the foreground extracting apparatus 100 may extract the first candidate foreground using a cascade classifier constructed based on various features of the encoding parameters. Here, the reason for utilizing the cascade classifier is to minimize the influence of noise that may be included in the encoding parameters. Details thereof will be described later with reference to FIG. 7.

Next, the foreground image extracting apparatus 100 extracts a second candidate foreground for the foreground extraction target frame using a preset image processing algorithm (S400). As the preset image processing algorithm, any image processing algorithm such as a frame difference-based image processing algorithm or a GMM-based processing algorithm may be used.

In an embodiment, a plurality of second candidate foregrounds may be extracted using a plurality of image processing algorithms. That is, the foreground image extracting apparatus 100 may extract n second candidate foregrounds such as 2-1st candidate foreground, . . . , and 2-nth candidate foreground, using n image processing algorithms (n is a natural number of 2 or more). According to this embodiment, the accuracy and reliability of the result of the extracted final foreground can be improved compared to when one second candidate foreground is used.

In the above embodiment, the value of n may be a predetermined fixed value or a variable value that varies depending on the situation. For example, as the computing performance of the foreground extracting apparatus 100 increases, as the resolution of the foreground extraction target frame decreases, or as the accuracy requirement of the intelligent image analysis system, the value of n may be a variable value that is set to a large value.

Next, the foreground extracting apparatus 100 determines a final foreground for the foreground extraction target frame using the first candidate foreground and the second candidate foreground (S500). According to this embodiment, the foreground extracting apparatus 100 may determine the final foreground using an MRF-based probability model. Details thereof will be described later with reference to FIG. 10.

Meanwhile, according to this embodiment, before performing the step (S500) of determining the final foreground, when the foreground classification units of the first candidate foreground and the second candidate foreground are different, a step of matching them may be performed. Here, the foreground classification unit refers to a size of a unit area in which foreground and background are classified in an image.

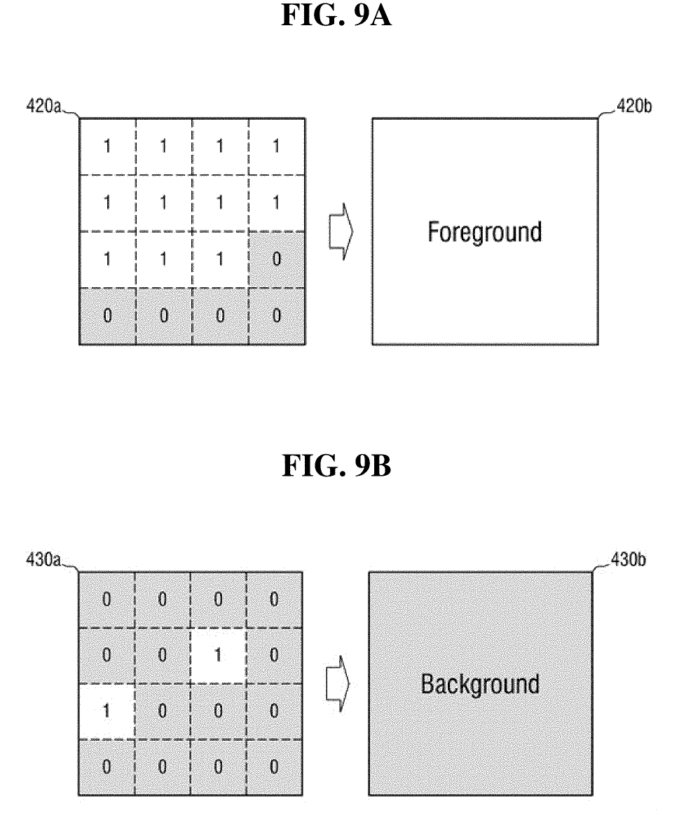

For example, since the encoding parameters are calculated in a unit of block (e.g., macroblock), the first candidate foreground extracted using the encoding parameters may be a candidate foreground in which a foreground and a back ground are classified in a unit of block. In contrast, the second candidate foreground extracted using the image processing algorithm such as GMM may be a candidate foreground in which a foreground and a background are classified in a unit of pixel. Like this, when foreground classification units are different from each other as a block and a pixel, a step of matching the foreground classification unit of the first candidate foreground with the foreground classification unit of the second candidate foreground may be performed. A detailed description thereof will be described with reference to examples shown in FIGS. 9A and 9B.

Up to now, the foreground extracting method according to the embodiment of the present invention has been described with reference to FIG. 6. According to the above description, the final foreground may be determined using both the first candidate foreground extracted using the encoding parameters and the second candidate foreground extracted through the image processing algorithm. Further, the final foreground may be determined using an MRF-based probability model. Accordingly, accuracy and reliability higher than a certain level can be guaranteed with respect to the foreground extraction result.

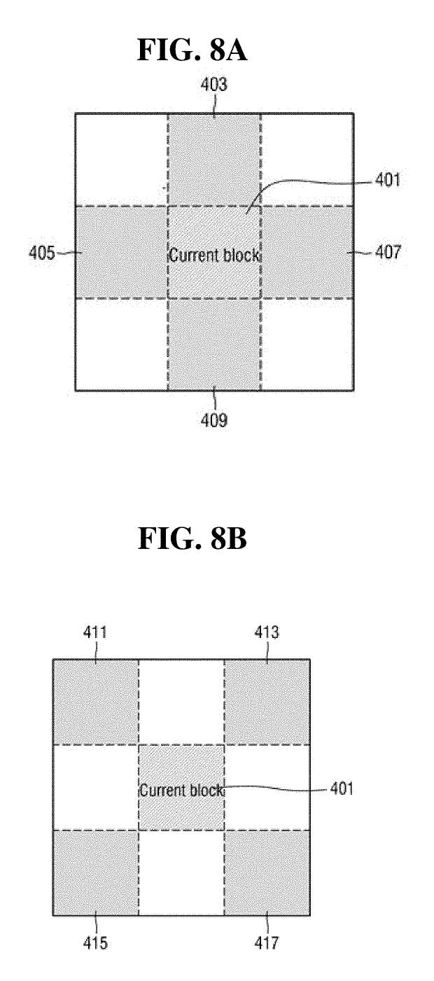

Hereinafter, the step (S300) of extracting the encoding parameter-based first candidate foreground will be described in detail with reference to FIGS. 7 to 8B.

According to an embodiment, the foreground extracting apparatus 100 may extract the first candidate foreground through a cascade classifier using various features based on the encoding parameters as classification criteria. Here, the cascade classifier refers to a classifier that classifies each block included in the foreground extraction target frame into foreground or background by sequentially performing a plurality of classification steps. For reference, each of the plurality of classification steps may be referred to as a step-by-step classifier.

In some embodiments of the present invention, the cascade classifier may include a first-step classifier using features based on the first encoding parameter and a second-step classifier using features based on the second encoding parameter. The first-step classifier may include a 1-1-step classifier using a first feature based on the first encoding parameter (hereinafter, briefly referred to as a “first parameter feature”) and/or a 1-2-step classifier using a second feature based on the second encoding parameter (hereinafter, briefly referred to as a “second parameter feature”). Like this, the kind and number of the encoding parameters used in the cascade classifier, and the kind and number of the features based on the encoding parameters may be changed depending on embodiments.

Hereinafter, a cascade classifier-based foreground extracting method performed in the step (S300) will be described in more detail with reference to the cascade classifier shown in FIG. 7. FIG. 7 shows an example of a cascade classifier for classifying input blocks using motion vector features into background or foreground.

Referring to FIG. 7, when a first block is input, it is determined in the step (S310) whether or not a first motion vector feature for the first block satisfies a first classification condition. As a result of determination, if first classification condition is not satisfied, the first block may be classified as a background (S310, S350). Further, if the first classification condition is satisfied, it is determined in the step (S320) whether or not a second motion vector feature satisfies a second classification condition. As a result of determination, if the second classification condition is not satisfied, the first block may be classified as a background (S320, S350). After such procedures are repeated, if the n-th motion vector feature of the first block satisfies the n-th classification condition in the n-th step (S330), the cascade classifier may classify the first block as a foreground (S330, S340).

As described above, it should be noted that the motion vector-based cascade classifier shown in FIG. 7 is merely an embodiment of the present invention which is provided to facilitate understanding. The number of classification steps (or classifiers) constituting the cascade classifier, the combination order of each classification step, and the branching route according to the determination result of each classification step may be varied according to embodiments. For example, the cascade classifier may be configured to classify the block as a foreground if any one classification condition is satisfied, and may also be configured to classify the block as a foreground if the number of satisfied classification conditions is a threshold value or more. As such, it should be noted that the cascade classifier can be configured in various ways.

Hereinafter, the encoding parameters that can be used in each classification step of the above cascade classifier, the features based on the encoding parameters, and the classification conditions based on the features will be described.

In an embodiment, a motion vector may be used as a classification criterion of the cascade classifier. Further, the length (or size) and direction of the motion vector may be used as the features of the motion vector, and the comparative result between the motion vector feature of a classification target block and the motion vector features of peripheral blocks may also be used.

Specifically, for example, in the specific classification step, a determination may be performed as to whether the length of the motion vector length of a classification target block is a first threshold value or less, and the classification target block may be classified as a background if the length of the motion vector length is a first threshold value or less.

As another example, in the specific classification step, a determination may be performed as to whether the length of the motion vector length of the corresponding block is a second threshold value or more, and the corresponding block may be classified as a background if the length of the motion vector length is a second threshold value or more. If the length of the motion vector is excessively large, the block is likely to be noise.

As another example, in the specific classification step, classification target blocks may be classified based on the comparative result between the motion vector feature of the classification target block and the motion vector features of peripheral blocks adjacent to the classification target block. Here, as shown in FIGS. 8A and 8B, the adjacent peripheral blocks may be peripheral blocks 403 to 409 located at the upper, lower, left, and right sides of the classification target block 401, or may be blocks 411 to 417 in a diagonal direction of the classification target block 401. However, the adjacent peripheral blocks are not limited thereto, and may also include peripheral blocks located within a predetermined distance from the classification target block. Examples of the features of the motion vector to be compared may include the presence, length, and direction of the motion vector. More specifically, for example, when the number of blocks having a motion vector among the peripheral blocks is a threshold value or less, the corresponding blocks may be classified as a background. As another example, when the number of blocks having a motion vector length of a first threshold value or less or a second threshold value or more which is more than the first threshold value, the corresponding block may be classified as a background. That is, when the number of blocks classified as background among the peripheral blocks is a threshold value or more, the classification target block may also be classified as background. As another example, when the number of peripheral blocks having a motion vector having a direction difference of a threshold angle or more from the motion vector of the classification target block, the corresponding blocks may be classified as background because they are more likely to be noise.

In an embodiment, DCT coefficients may be used as the classification criterion of the cascade classifier. For example, among the peripheral blocks located within a predetermined distance from the classification target block, when the number of peripheral blocks having a DCT coefficient of not 0 is a threshold value or less, the corresponding blocks may be classified as background.

In an embodiment, partition information including the number and size of prediction blocks may be used the classification criterion of the cascade classifier. The partition information indicates information about a prediction block included in a macroblock, and it will be obvious to those skilled in the art, so that a description thereof will be omitted. For example, when the number of prediction blocks included in the classification target block is a threshold value or more or the number of prediction blocks having a predetermined size or less, the classification target block may be classified as foreground. In the opposite case, the classification target block may be classified as background. Generally, the reason for this is that a foreground object is characterized in that it is composed of a large number of small prediction blocks. As another example, the number of prediction blocks among the peripheral blocks of the classification target blocks is a threshold value or more and/or the number of the peripheral blocks having a predetermined size or less satisfying the condition of the number of prediction blocks being threshold value or more is a threshold value or more, the classification block may be classified as foreground.

For reference, the number of classification steps (or classifiers) constituting the above-described cascade classifiers may be a predetermined fixed value or a variable value that varies depending on the situation. For example, as the computing performance of the foreground extracting apparatus 100 increases, as the resolution of the foreground extraction target frame decreases, or as the accuracy requirement of the intelligent image analysis system, the number of classification steps may be a variable value that is set to a large value.

Up to now, a cascade classifier-based foreground classifying method that can be referred to in some embodiments of the present invention has been described with reference to FIGS. 7 to 8B. According to the above-described method, since the classification is performed through a plurality of classification steps constituting the cascade classifier, an effect of purifying the noise contained in the encoding parameters can be created. Therefore, a foreground extraction result having resistance to noise and high reliability can be provided. Further, since the encoding parameters are information that is naturally derived in the decoding process of an image, a separate operation is not performed to acquire the encoding parameters, and the cascade classifier also does not perform complex operations, so that the foreground extraction result can be provided quickly.

Hereinafter, a method of matching the classification units of the first candidate foreground and the second candidate foreground will be described with reference to FIGS. 9A and 9B.

According to embodiments of the present invention, the foreground extracting apparatus 100 may match the classification units of the first candidate foreground and the second candidate foreground based on the block size which is a classification unit of the first candidate foreground. This matching is performed in order to reduce the complexity of an operation used in the foreground extraction by performing an operation in a unit of block at the time of determining a final foreground.

Specifically, the foreground extracting apparatus 100 groups the pixels included in the second candidate foreground into respective blocks. At this time, the grouping may be performed so that the position and size of each block correspond to each block of the first candidate foreground. The foreground extracting apparatus 100 may match the classification units of the first candidate foreground and the second candidate foreground by classifying each of the blocks included in the second candidate foreground as foreground or background according to Equation 1 below. In Equation 1, σᵤ indicates the classification result of block u, j indicates an index of a pixel included in the block u, N(A) indicates the number of pixels A classified as foreground, and T indicates a threshold value. The classification result “0” indicates a case where the block is classified as background, and the classification result “1” indicates a case where the block is classified as foreground.

$${σ}_{u} = \{ \begin{matrix}1 , & if {\sum }_{j} N ( {u}_{j} = 1 ) > T \\ 0 , & otherwise \end{matrix} \qquad [ Equation 1 ]$$

In Equation 1, the threshold value T may be a predetermined fixed value or may be a variable value that varies depending on the situation. For example, the threshold value T may be a variable value set to a smaller value when the number of blocks classified as foreground among the adjacent peripheral blocks is equal to or more than the threshold value, and may be a variable value set to a larger value when the number of blocks classified as background among the adjacent peripheral blocks is equal to or more than the threshold value.

FIGS. 9A and 9B shows an example where the block of the second candidate block is classified as foreground or background according to Equation 1 when the size of a unit block, which is a classification unit of the first candidate foreground, is 4×4, and the threshold value T is 9. Specifically, FIG. 9A shows a case where the corresponding block 420a is classified as foreground, and FIG. 9B shows a case where the corresponding block 430a is classified as background.

Referring to FIGS. 9A and 9B, since the number of pixels classified as foreground is 11, the block 420a of the second candidate foreground is classified as foreground like the block 420b. Further, since the number of pixels classified as foreground is 2, the block 430a of the second candidate foreground is classified as background like the block 430b.

Up to now, the method of matching the classification units of the first candidate foreground and the second candidate foreground has been described with reference to FIGS. 9A and 9B. According to the above method, the second candidate foreground in a unit of pixel may be converted into the second candidate in a unit of block based on the classification unit of the first candidate foreground. In this procedure, since foreground and background are classified in a unit of block by integrating the classification results of peripheral pixels, there may be an effect of removing noise included in the second candidate foreground.

Hereinafter, the step (S500) of determining the final foreground will be described in detail using an MRF-based probability model.

FIG. 10 shows an MRF model that may be referenced in some embodiments of the present invention.

Referring to FIG. 10, assuming that the final foreground is determined in a unit of block, w indicates the classification result of the first block 460 included in the final foreground, v indicates the classification result of the second block 440 corresponding to the first block 460 in the first candidate foreground, and u indicates the classification result of the third block 450 corresponding to the first block 460 in the second candidate foreground.

According to embodiments of the present invention, the foreground extracting apparatus 100 may determine the classification result w of each block included in the final foreground so that the energy value of the energy function described in Equation 2 below is minimized. Since those skilled in the art can obviously understand that a foreground extracting process can be modeled into a problem of minimizing the energy value of an MRF-based energy function, a detailed description thereof will be omitted. Further, those skilled in the art can obviously understand that Equation 2 below is determined based on the MRF model shown in FIG. 10.

E=αEᵥ+βEᵤ+E_{ω} [Equation 2]

In Equation 2, the first energy term Ev indicates an energy term according to the relationship between the first block of the final foreground and the second block of the first candidate foreground, the second energy term Eu indicates an energy term according to the relationship between the first block of the final foreground and the third block of the second candidate foreground, and the third energy term Eω indicates an energy term according to the relationship between the first block of the final foreground and the peripheral block adjacent to the first block. α and β indicate scaling factors controlling the weighted value of each energy term. Hereinafter, a method of calculating the energy value of each energy term will be described.

According to embodiments of the present invention, the energy value of the first energy term Ev may be calculated using energy values of a plurality of frames including a foreground extracting frame in order to consider temporal continuity between image frames. The reason for this is that unit blocks classified as foreground in both the previous frame and the subsequent frame of the foreground extraction target frame are likely to be classified as foreground in the current frame.

Specifically, the first energy term Ev may be calculated by accumulating the energy values of the previous frame, the foreground extraction target frame, and the subsequent frame. This is expressed by Equation 3 below. In Equation 3, Ev^{t} indicates a energy term of the foreground extraction target frame (t), Ev^{t-1} and Ev^{t+1} indicate energy terms of the previous frame (t−1) and the subsequent frame (t+1), respectively, and the first energy term Ev is calculated based on three consecutive frames.

Eᵥ=Eᵥ^{t-1}+Eᵥ^{t}+Eᵥ^{t+1} [Equation 3]

Each of the energy terms shown in Equation 3 may be calculated according to Equation 4 below. In Equation 4, Dv (vi,ω) indicates the similarity between the first block (ω) of the final foreground and the second block (vi) of the first candidate foreground. In Equation 4, the minus sign means that as the similarity between two blocks increases, the energy value of each energy term is determined to have a smaller value.

Eᵥ^{f}=−Dᵥ^{f}(vᵢ,ω) [Equation 4]

In Equation 4, the similarity between two blocks may be calculated by using, for example, sum of squared difference (SSD), sum of absolute difference (SAD), or whether the labels indicating the classification result (e.g. 1 is foreground and 0 is background), but may also be calculated by any method.

Next, the energy value of the second energy term Eu may be calculated according to Equations 5 and 6 below. The second energy term Eu may also be calculated by accumulating the energy values of the previous frame, the foreground extraction target frame, and the subsequent frame in consideration of temporal continuity. Descriptions of Equations 5 and 6 below will be omitted because they are the same as those for calculating the energy value of the first energy term (Ev).

Eᵤ=Eᵤ^{t-1}+Eᵤ^{t}+Eᵤ^{t+1} [Equation 5]

Eᵤ^{f}=−Dᵤ(σᵤ^{f},ω) [Equation 6]

Next, the energy value of the third energy term Eω may be calculated according to Equations 7 below in consideration of similarity of the corresponding block and the peripheral block. This can be understood that, considering the characteristics of a rigid body having a compact form, if the peripheral block is classified as a foreground object, the corresponding block is also likely to be included in the same foreground object. In Equation 7, first peripheral blocks (1^{st}-order neighborhood blocks) may be peripheral blocks located within a first distance, for example, upper, lower, left and right peripheral blocks. Further, second peripheral blocks (2^{nd}-order neighborhood blocks) may be peripheral blocks located within a second distance greater than the first distance, for example, diagonal peripheral blocks, but the present invention is not limited thereto.

$${E}_{ω} = - {γ}_{1} {\sum }_{{k ∈ 1 st \text{-} order}_{neighborhood}} {D}_{ω} ( {ω}_{k} , ω ) - {γ}_{2} {\sum }_{{k ∈ 2 nd \text{-} order}_{neighborhood}} {D}_{ω} ( {ω}_{k} , ω ) \qquad [ Equation 7 ]$$

Further, in Equation 7, in order to give a higher weighted value to the similarity with the first peripheral block at a closer distance, the energy term coefficient γ1 for the first peripheral block may be set to a higher value than the energy term coefficient γ2 for the second peripheral block, but the present invention is not limited thereto.

The final foreground classification result indicating the solution of Equation 2 may be determined using an algorithm such as ICM (Iterated Conditional Modes) or SR (Stochastic Relaxation). Since the solution of the above Equations is already obvious to those skilled in the art, and a description thereof will be omitted.

According to embodiments of the present invention, the solution according to Equation 2 can be derived for each block included in the final foreground. In other words, an operation for deriving the solution of Equation 2 in a unit of pixel may not be performed, but an operation for deriving the solution of Equation 2 in a unit of block may be performed. Thus, the complexity of the operation for the final foreground determining (step S500) can be greatly reduced.

Meanwhile, according to embodiments of the present invention, a plurality of second candidate foregrounds may be used to determine the final foreground using a plurality of image processing algorithms. In this case, Equation 2 above can be expanded as shown in Equation 8 below. In Equation 8 below, the first energy term (Ev) indicates an energy term for the first candidate foreground, the 2-1st energy term (Eu₁) indicates an energy term relating to the 2-1st candidate foreground, and the 2-nth energy term (Euₙ) indicates the energy term for the 2-nth candidate foreground.

E=αEᵥ+β₁Eᵤ_{₁}+ . . . +βₙEᵤ_{ₙ}+E_{ω} [Equation 8]

According to an embodiment, a plurality of first candidate foregrounds may be used. For example, a 1-1st candidate foreground determined through a motion vector-based cascade classifier, a DCT coefficient, and/or a 1-2nd candidate foreground determined through a partition information-based cascade classifier may be used to determine the final foreground. In this case, the energy function based on the MRF model may include a plurality of first energy terms.

According to an embodiment, the final foreground may be determined using only the first candidate foreground in order to provide faster foreground extraction results. In this case, in Equation 2, the final foreground may be determined by setting the coefficient factor (β) to zero. For example, if the intelligent image analysis system provides a heat map for flow population through image analysis, the accuracy of the foreground extraction may not be high. Therefore, in this case, a first candidate foreground is extracted, and the final foreground may be quickly provided using only the first candidate foreground. For reference, according to the experimental results to be described later with reference to FIGS. 14 and 15, it can be ascertained that accuracy more than a predetermined level is secured even if the final foreground is determined by using only the first candidate foreground.

Up to now, a method of determining the final foreground using the MRF-based probability model in step S500 has been described in detail with reference to FIG. 10. As described above, the final foreground having high accuracy and reliability can be determined by using the MRF-based probability model, and the processing performance of foreground extraction can also be improved by performing operations in a unit of block.

Next, comparative experimental results of a conventional foreground extracting method and a foreground extracting method according to some embodiments of the present invention will be briefly described with reference to FIGS. 11A to 16.

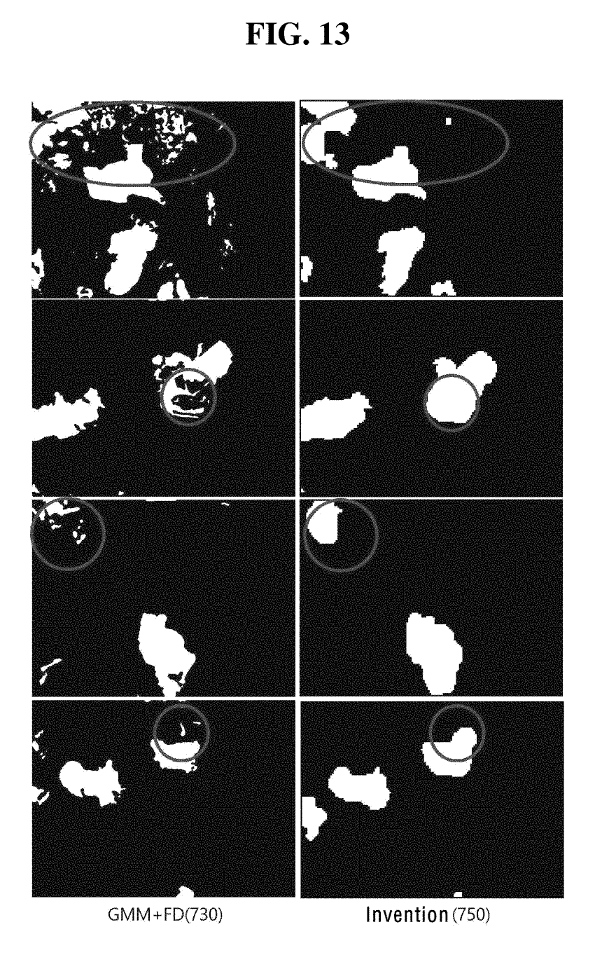

FIGS. 12 and 13 show the comparative experimental results according to the foreground extracting method shown in FIGS. 11A and 11B. Specifically, FIG. 12 shows the measurement results for average processing time per frame, and FIG. 13 shows actually extracted foreground results. FIG. 11A shows the configuration (510, 530, 550) of the proposed foreground extracting method, and FIG. 11B shows the configuration (610, 630, 650) of the conventional foreground extracting method to be compared. In the case of the foreground extracting method according to an embodiment of the present invention, it is assumed that a motion vector-based cascade classifier and a GMM-based image processing algorithm are used. In the case of the conventional foreground extracting method, it is assumed that a frame difference-based image processing algorithm and a GMM-based image processing algorithm are used and post-processing through a morphology operation is performed to remove noise.

Referring to FIG. 12, comparing the processing time per frame taken to extract the foreground from images (A, B, C, and D) having a resolution of 640×480, it can be found that on average, the proposed foreground extracting method shows processing time improved by 12% or more.

Further, referring to the foreground extraction results (730 and 750) of FIG. 13, it can be found that the proposed foreground extracting method separates foreground and background more effectively. According to the result (750) extracted by the proposed foreground extraction method, it can be seen that there is no hole and a boundary is smooth as compared with the conventional method. Thus, it may be advantageous to find a center point when creating each blob of an object. Further, referring to circled portions, it can be found that the portions that are not well extracted by the conventional method because foreground and background colors are similar to each other can be extracted accurately according to the proposed method.

In summary, it can be seen that the proposed method rapidly provides foreground extraction results while eliminating noise as compared with the conventional method.

Next, a case of determining the final foreground using only the first candidate foreground according to the embodiment of the present invention and comparative experimental results using the GMM-based image processing algorithm and the frame difference-based image processing algorithm will be described with reference to FIGS. 14 and 15. Even in the experimental results, in the GMM-based image processing algorithm and the frame difference-based image processing algorithm, post-processing through a morphology operation was performed.

FIG. 14 shows the measurement result for average processing time per frame, and FIG. 15 shows the result of foreground extraction.

Referring to FIG. 14, it can be found that in the case of the proposed method, processing performance is improved by 75% or more as compared with the conventional GMM-based or frame difference-based image process algorithm. That is, it can be found that the proposed method has remarkably low complexity as compared with the conventional method.

Referring to the foreground extraction results (810, 830, and 850) shown in FIG. 15, it can be found that even if only the first candidate foreground is used, the proposed method can provide a reliable foreground extraction result that is robust against noise and has a certain level or more as compared with the conventional method.

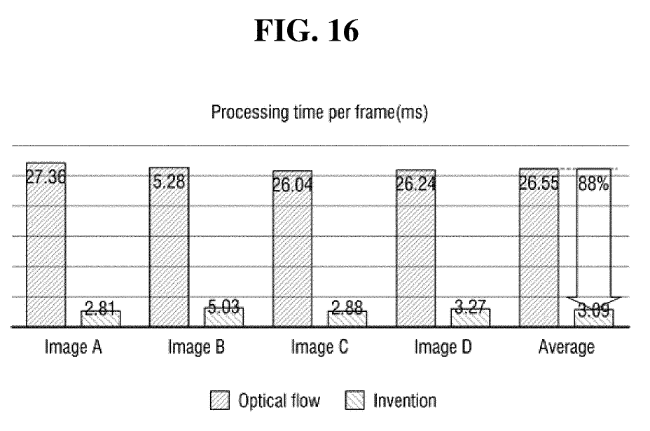

Finally, comparative experimental results for conventional optical flow and the proposed method will be described with reference to FIG. 16. Here, the proposed method, similarly to the experimental environments of FIGS. 14 and 15, refers to a foreground extracting method using only the first candidate foreground.

As a typical method of performing motion estimation in an image, there is a method of using a block matching algorithm and an optical flow. The motion estimation result can be obtained by using the motion vector calculated through the block matching algorithm, but there is a disadvantage in that when the block matching algorithm is used, accuracy is lowered because the motion vector includes noise, compared to when the optical flow is used. However, when the method proposed in the embodiment of the present invention is used, the noise included in the motion vector is purified through the cascade classifier and the MRF model, so that the optical flow may be replaced. For example, the foreground extraction result according to the proposed method is defined as a motion map, and the motion vector value of the corresponding block is output only when the value of the motion map of the corresponding block is 1 (that is, when classified as foreground), thereby rapidly acquiring the motion estimation result.

Although various optical flow algorithms exist, a dense optical flow technique for calculating the optical flow in a unit of pixel is complex in operation to be applied to an actual system, so that a sparse optical flow technique for extracting several feature points and then calculating the optical flow for the feature points is generally used.

FIG. 16 shows the results of measuring the processing time per frame of motion estimation according to the sparse optical flow technique and the proposed method.

As shown in FIG. 16, it can be found that the proposed method shows performance improved by 88% or more as compared with the sparse optical flow technique. Therefore, it can be seen that the proposed method can be substituted for the optical flow in the field of computer vision when applied to motion estimation.

Up to now, the comparative experimental results of the conventional foreground extracting method and the proposed foreground extracting method according to some embodiments of the present invention have been briefly described with reference to FIGS. 11A to 16. According to the above-described comparative experimental results, it can be found that, when the proposed foreground extracting method was used, accuracy of the foreground extraction results was improved and processing performance was also greatly improved, compared to when the conventional methods were used.

The concepts of the present invention having been described above with reference to FIGS. 2 to 16 may be implemented as a computer-readable code on a computer-readable recording medium. For example, the computer-readable recording medium may be a mobile recording medium (CD, DVD, blue-ray disk, USB storage device, or removable hard disk), or may be a fixed recording medium (ROM, RAM, or computer-equipped hard disk). The computer program recorded in the computer-readable recording medium may be transmitted to another computing apparatus via a network such as the Internet and installed in another computing apparatus, and thus this computer program may be used in the another computing apparatus.

Although operations are shown in a specific order in the drawings, it should not be understood that desired results can be obtained only when the operations must be performed in the specific order shown in the drawings or in a sequential order, or all the shown operations must be performed. In certain situations, multitasking and parallel processing may be advantageous. Moreover, it should not be understood that the separation of the various configurations in the above-described embodiments is necessarily required, and it should be understood that the described program components and systems may generally be integrated together into a single software product or packaged into a plurality of software products.

As described above, according to the embodiments of the present invention, a candidate foreground is extracted using en encoding parameter calculated in the encoding process of an image. Since the encoding parameter is information calculated in the encoding process including complicated operations, a relatively accurate foreground can be extracted even with a small number of operations. Moreover, the encoding parameters are not directly used for candidate foreground extraction but the classification is performed through a plurality of classification steps constituting the cascade classifier, so that the noise included in the encoding parameters can be purified. Therefore, there is provided an effect that a foreground extraction result is relatively resistant to noise and has high reliability.

Further, since the encoding parameters are information derived naturally in the image decoding process, it is not necessary to perform additional operations to acquire the encoding parameters. Further, since the cascade classifier does not perform an operation with high complexity, there is an effect that the foreground extraction result can be provided quickly.

Further, the final foreground can be determined using both the first candidate foreground extracted using the encoding parameters and the second candidate foreground extracted using a pixel-based image processing algorithm. Here, the final foreground may be determined using a markov random field (MRF)-based probability model. Accordingly, the accuracy and reliability of the foreground extraction result can be improved compared to those of conventional art.

In addition, the process of determining the final foreground using the MRF-based probability model is performed in a unit of block rather than in a unit of pixel. Therefore, the complexity of operations for foreground extraction is reduced, so that the accuracy of the foreground extraction result can be improved, and the processing performance of foreground extraction can also be improved.

The effects of the present invention are not limited by the foregoing, and other various effects are anticipated herein.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Exemplary embodiments of the present invention have been described with reference to the accompanying drawings. However, those skilled in the art will appreciate that various modifications, additions and/or substitutions are possible, without materially departing from the scope and spirit of the present invention. All such modifications are intended to be included within the scope of the present invention as defined by the following claims, with equivalents of the claims to be included therein. Although the present invention has been particularly shown and described with reference to exemplary embodiments thereof, it is to be understood that the foregoing is illustrative and is not to be construed as limiting the scope of the present invention.

What is claimed is:

1. A method of image processing, the method comprising:
acquiring encoded image data corresponding to an original image;
decoding the encoded image data;
acquiring a foreground extraction target frame and an encoding parameter associated with an encoding process of the original image, based on decoding the encoded image data;
extracting a first candidate foreground associated with the foreground extraction target frame based on the encoding parameter;
extracting a second candidate foreground associated with the foreground extraction target frame based on an image processing algorithm; and
determining a final foreground associated with the foreground extraction target frame based on the first candidate foreground and the second candidate foreground.

2. The method of claim 1, wherein the encoding parameter includes at least one of a motion vector, a discrete cosine transform (DCT) coefficient, or partition information associated with a number and size of prediction blocks.

3. The method of claim 1, wherein the extracting of the first candidate foreground comprises classifying each classification target block included in the foreground extraction target frame as foreground or background using a cascade classifier based on the encoding parameter.

4. The method of claim 3, wherein the encoding parameter includes a motion vector, and
wherein the cascade classifier includes:
a first-step classifier that classifies each classification target block as foreground or background based on a length of the motion vector; and
a second-step classifier that classifies each classification target block as foreground or background based on a comparative result of respective motion vectors of respective classification target blocks and respective motion vectors of respective peripheral blocks located within a predetermined distance from the respective classification target blocks.

5. The method of claim 4, wherein the first-step classifier includes:
a 1-1-step classifier that classifies a classification target block as background based on a length of the motion vector of the classification target block being less than or equal to a first threshold value; and
a 1-2-step classifier that classifies the classification target block as background based on the length of the motion vector of the classification target block being greater than or equal to a second threshold value that is greater than the first threshold value.

6. The method of claim 4, wherein the second-step classifier includes:
a 2-1-step classifier that classifies the classification target block as background based on a number of motion vectors, associated with a plurality of peripheral blocks located within a first distance of the classification target block, being less than or equal to a first threshold value; and
a 2-2-step classifier that classifies the classification target block as background based on the number of motion vectors being less than or equal to a second threshold value.

7. The method of claim 3, wherein the encoding parameter includes a DCT coefficient, and
wherein the cascade classifier includes:
a classifier that classifies a classification target block as background based on a number of peripheral blocks having a non-zero discrete cosine transform (DCT) coefficient, among a plurality of peripheral blocks located within a predetermined distance from the classification target block, being less than or equal to a threshold value.

8. The method of claim 3, wherein the encoding parameter includes partition information associated with a number and size of prediction blocks, and
the cascade classifier includes a classifier that classifies a classification target block as foreground or background based on the number and size of prediction blocks included in the classification target block.

9. The method of claim 1, wherein the first candidate foreground is a candidate foreground in which foreground and background are classified in a unit of block, and the second candidate foreground is a candidate foreground in which foreground and background are classified in a unit of pixel, and
wherein the determining of the final foreground associated with the foreground extraction target frame comprises:
matching a first classification unit of the first candidate foreground and a second classification unit of the second candidate foreground based on the first classification unit of the first candidate foreground; and
determining the final foreground based on matching the first classification unit of the first candidate foreground and the second classification unit of the second candidate foreground.

10. The method of claim 9, wherein the matching of the first classification unit of the first candidate foreground and the second classification unit of the second candidate foreground comprises:
grouping a plurality of pixels associated with the second candidate foreground into respective blocks wherein each of the respective blocks corresponds to blocks associated with the first candidate foreground; and
determining blocks in which a number of pixels, classified as foreground, is greater than or equal to a threshold value as being foreground.

11. The method of claim 1, wherein the determining of the final foreground associated with the foreground extraction target frame comprises:
determining the final foreground such that an energy value of a Markov random field (MRF) model-based energy function is minimized, and
wherein the MRF model-based energy function includes a first energy term based on a similarity between the first candidate foreground and the final foreground, a second energy term based on a similarity between the second candidate foreground and the final foreground, and a third energy term based on a similarity between a specific region of the final foreground and a peripheral region of the specific region.

12. The method of claim 11, wherein the determining of the final foreground such that the energy value of the MRF model-based energy function is minimized comprises:
performing an operation of minimizing the energy value of the MRF model-based energy function in a unit of block to determine the final foreground.

13. The method of claim 11, wherein an energy value of the first energy term and an energy value of the second energy term are determined based on a first energy value associated with the foreground extraction target frame, a second energy value associated with a preceding frame associated with the foreground extraction target frame, and a third energy value for a subsequent frame associated with the foreground extraction target frame.

14. The method of claim 11, wherein the energy value of the third energy term is determined based on a first similarity between the specific region and a first peripheral region located within a first distance of the specific region and a second similarity between the specific region and a second peripheral region located within a second distance of the specific region, and
wherein the first distance is less than the second distance.

15. The method of claim 14, wherein the energy value of the third energy term is determined based on a sum of weighted values associated with the first similarity and the second similarity, and
wherein a first weighted value associated with the first similarity is greater than a second weighted value associated with the second similarity.

16. A method of image processing, the method comprising:
acquiring encoded image data associated with an original image that was encoded based on an encoding process;
decoding the encoded image data and acquiring a foreground extraction target frame and an encoding parameter associated with the encoding process based on decoding the encoded image data, wherein the encoding parameter includes a motion vector; and
extracting a foreground associated with the foreground extraction target frame using a cascade classifier based on the motion vector.

17. The method of claim 16, wherein the cascade classifier includes:
a first-step classifier that classifies a classification target block, of the foreground extraction target frame, as foreground or background based on a length of the motion vector; and
a second-step classifier that classifies the classification target block as foreground or background based on a comparative result of a motion vector of the classification target block and a motion vector of a peripheral block located within a predetermined distance of the classification target block.

18. The method of claim 17, wherein the first-step classifier includes:
a 1-1-step classifier that classifies the classification target block as background based on the length of the motion vector of the classification target block being less than or equal to a first threshold value; and
a 1-2-step classifier that classifies the classification target block as background based on the length of the motion vector of the classification target block being greater than or equal to a second threshold value that is greater than the first threshold value.

19. The method of claim 17, wherein the second-step classifier includes:
a 2-1-step classifier that classifies the classification target block as background based on a number of motion vectors associated with a plurality of peripheral blocks located within a first distance of the classification target block being less than or equal to a first threshold value; and
a 2-2-step classifier that classifies the classification target block as background based on a number of motion vectors associated with a plurality of peripheral blocks located within a second distance, that is greater than the first distance, being less than or equal to a second threshold value.

20. The method of claim 16, wherein the extracting of the foreground associated with the foreground extraction target frame comprises:
extracting a final foreground associated with the foreground extraction target frame using the cascade classifier; and
determining the final foreground associated with the foreground extraction target frame based on a candidate foreground such that an energy value of a Markov random field (MRF) model-based energy function is minimized, and
wherein the MRF model-based energy function includes a first energy term based on a similarity between the candidate foreground and the final foreground and a second energy term based on a similarity between a specific region of the final foreground and a peripheral region of the specific region.

21. The method of claim 16, wherein the extracting of the foreground associated with the foreground extraction target frame comprises:
extracting a first candidate foreground associated with the foreground extraction target frame using the cascade classifier;
extracting a second candidate foreground associated with the foreground extraction target frame using a preset image processing algorithm; and
determining a final foreground associated with the foreground extraction target frame based on the first candidate foreground and the second candidate foreground.

22. The method of claim 21, wherein the determining of the final foreground associated with the foreground extraction target frame comprises: determining the final foreground such that an energy value of a Markov random field (MRF) model-based energy function is minimized, and
wherein the MRF model-based energy function includes a first energy term based on a similarity between the first candidate foreground and the final foreground, a second energy term based on a similarity between the second candidate foreground and the final foreground, and a third energy term based on a similarity between a specific region of the final foreground and a peripheral region of the specific region.

23. An image processing apparatus comprising:
a memory configured to store instructions; and
at least one processor configured to execute the instructions to:
acquire encoded image data generated through an encoding process performed on an original image;
perform a decoding process on the encoded image data and acquire a foreground extraction target frame and an encoding parameter associated with the encoding process based on the decoding process;
extract a first candidate foreground associated with the foreground extraction target frame using the encoding parameter;
extract a second candidate foreground associated with the foreground extraction target frame using a preset image processing algorithm; and
determine a final foreground associated with the foreground extraction target frame based on the first candidate foreground and the second candidate foreground.
